(19) United States
(12) Patent Application Publication
(10) Pub. No.: US 2012/0226593 A1
(43) Pub. Date: Sep. 6, 2012

(54) Method and System for Exchange Traded Funds Request Management

(75) Inventors: Colin A. Peters, Plainfield, NJ (US); Maria L. Slavin, Montclair, NJ (US); Eric J. Grappi, Summit, NJ (US); Michael Pagano, Staten Island, NY (US); Yuriy Klubok, Brooklyn, NY (US); Boris Shlenskiy, Staten Island, NY (US); Maxine A. Soloway, Brooklyn, NY (US); Yalixa De La Cruz, Westbury, NY (US); John H. Olivares, Elizabethport, NJ (US); Justine Hughes, New York, NY (US); Johnny P. Lozada, Pompton Lakes, NJ (US); Theodore B. Teschner, Chatham, NJ (US); Alyssa Trocino, Howard Beach, NY (US); Geoffrey T. Mrema, New York, NY (US); Anna K. Dziekan, Hannacroix, NY (US); Scott W. Croland, Belle Mead, NJ (US); Brian R. Beyea, Lawrenceville, NJ (US)

(73) Assignee: Bank of America Corporation, Charlotte, NC (US)

(21) Appl. No.: 13/282,724

(22) Filed: Oct. 27, 2011

Related U.S. Application Data
(60) Provisional application No. 61/447,921, filed on Mar. 1, 2011.

(51) Int. Cl. G06Q 40/06

(52) U.S. Cl. 705/35

(57) ABSTRACT

A server includes a memory that stores a plurality of Exchange Traded Fund (ETF) request forms, and a processor communicatively coupled to the memory. The processor is operable to provide a graphical user interface (GUI) to a user in which to create an ETF request, receive the ETF request created using the GUI, determine, based on a ticker symbol of the ETF request, an ETF request form to use to process the ETF request, and populate the determined ETF request form using parameters of the ETF request. The processor is further operable to transmit the populated ETF request form to a placement agent associated with the populated ETF request form and indicate, using the GUI, that the ETF request has been processed after the ETF request form has been transmitted to the placement agent.

### CROSS-REFERENCE TO RELATED APPLICATION

This application claims the benefit of priority under 35 U.S.C. §119(e) of U.S. Provisional Application Ser. No. 61/447,921, entitled “METHOD AND SYSTEM FOR EXCHANGE TRADED FUNDS REQUEST MANAGEMENT,” filed Mar. 1, 2011.

### TECHNICAL FIELD OF THE INVENTION

The present invention relates generally to financial services and more specifically to a method and system for Exchange Traded Funds (ETF) request management.

### BACKGROUND OF THE INVENTION

Financial institutions, such as banks, offer many products and services to their clients. One such service is the ability to execute Exchange Traded Funds (ETF) transactions. For example, a client of a bank may submit a request to create or redeem a certain amount of a particular ETF. Typically, the execution of ETF requests is an inefficient and time-intensive operation.

### SUMMARY OF THE INVENTION

In accordance with the present invention, the disadvantages and problems associated with prior Exchange Traded Funds (ETF) transactions have been substantially reduced or eliminated.

According to one embodiment of the present invention, a server includes a memory that stores a plurality of Exchange Traded Fund (ETF) request forms, and a processor communicatively coupled to the memory. The processor is operable to provide a graphical user interface (GUI) to a user in which to create an ETF request, receive the ETF request created using the GUI, determine, based on a ticker symbol of the ETF request, an ETF request form to use to process the ETF request, and populate the determined ETF request form using parameters of the ETF request. The processor is further operable to transmit the populated ETF request form to a placement agent associated with the populated ETF request form and indicate, using the GUI, that the ETF request has been processed after the ETF request form has been transmitted to the placement agent.

Certain embodiments of the disclosure may provide one or more advantages. An advantage of one embodiment may be that a middle office of a financial institution may facilitate the communication of ETF requests between a client and a placement agent. In other embodiments, ETF requests may be processed accurately and efficiently.

Certain embodiments of the disclosure may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its advantages, reference is now made to the following description taken in conjunction with the accompanying drawings, in which:

FIG. 1 illustrates a system for providing ETF request management, according to certain embodiments;

FIG. 2 illustrates an example screenshot of a graphical user interface (GUI) that may be generated by the system of FIG. 1, according to certain embodiments; and

FIG. 3 illustrates a method for providing ETF request management, according to certain embodiments.

### DETAILED DESCRIPTION OF THE INVENTION

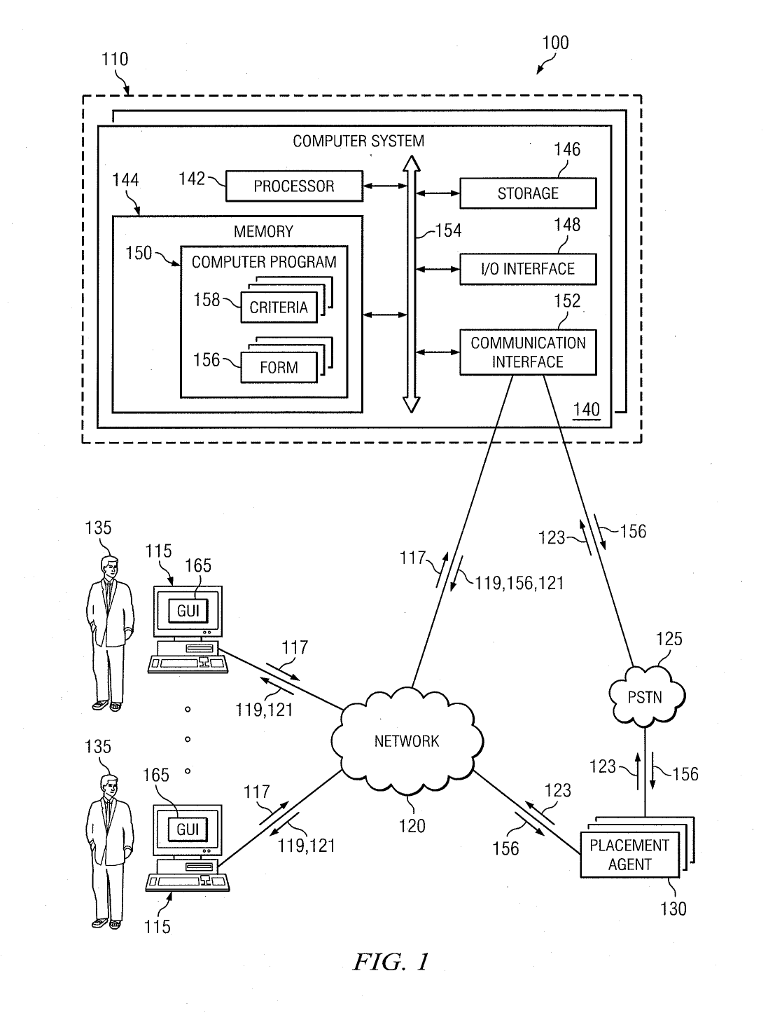

Embodiments of the present invention and its advantages are best understood by referring to FIGS. 1 through 3 of the drawings, like numerals being used for like and corresponding parts of the various drawings.

Banks and other financial institutions typically offer various services to their clients. One service that may be offered is the ability to facilitate stock, mutual fund, or Exchange Traded Fund (ETF) transactions. For example, a middle office of a bank may receive a request from one or more clients to create or redeem a certain amount of a particular ETF. After receiving the ETF request, the middle office may process the request by communicating with a placement agent who issued the ETF. Typically, however, the processing of ETF transactions between a client and a placement agent is inefficient, slow, and prone to errors.

The teachings of the disclosure recognize that it would be desirable to provide ETF request processing services to clients of a financial institution in a more efficient, accurate, and timely manner. FIGS. 1 through 3 below illustrate a method and system for ETF request management according to the teachings of the disclosure.

FIG. 1 illustrates a system 100 according to certain embodiments. System 100 may include an enterprise 110, one or more clients 115, one or more placement agents 130, and one or more users 135. Enterprise 110, clients 115, and placement agents 130 may be communicatively coupled by a network 120 and/or a public switched telephone network (PSTN) 125. Enterprise 110 is generally operable to provide improved ETF request processing services to users 135 as described below.

In general, one or more computer systems 140 of enterprise 110 may offer ETF request processing services to users 135 via clients 115. A user 135 may first utilize client 115 to provide an ETF request 117 to computer system 140. ETF request 117 may then be transmitted to computer system 140 over network 120 via email or any other suitable method. After receiving ETF request 117, computer system 140 may transmit acknowledgement 119 to user 135 via client 115 to indicate that ETF request 117 has been received or has been rejected. Computer system 140 may then determine, based on a ticker symbol in ETF request 117, an ETF request form 156 to use to process ETF request 117. Computer system 140 may then populate the determined ETF request form 156 using parameters of ETF request 117. After ETF request form 156 has been populated, it is transmitted to a placement agent 130 associated with the populated ETF request form 156 so that the ETF request 117 may be fulfilled. In some embodiments, ETF request form 156 may be transmitted as a facsimile over PSTN 125 or network 120. The placement agent 130 may then transmit a receipt 123 to computer system 140 as a confirmation that ETF request form 156 was received. Finally, computer system 140 may transmit a confirmation 121 to client 115 to indicate to user 135 that ETF request 117 has been processed. As a result, user 135 is provided ETF request processing services in a timely, efficient, and accurate manner.

Client 115 may refer to any device that enables user 135 to interact with computer system 140. In some embodiments, client 115 may include a computer, workstation, telephone, Internet browser, electronic notebook, Personal Digital Assistant (PDA), pager, or any other suitable device (wireless, wireline, or otherwise), component, or element capable of receiving, processing, storing, and/or communicating information with other components of system 100. Client 115 may also comprise any suitable user interface, display, microphone, keyboard, or any other appropriate terminal equipment usable by a user 135. It will be understood that system 100 may comprise any number and combination of clients 115. Client 115 may be utilized by user 135 to interact with computer system 140 in order to execute ETF requests as described below.

In some embodiments, client 115 may include a graphical user interface (GUI) 165. GUI 165 is generally operable to tailor and filter data presented to user 135, and to capture input data from user 135. GUI 165 may comprise a plurality of displays having forms, interactive fields, pull-down lists, and buttons operated by user. GUI 165 may include multiple levels of abstraction including groupings and boundaries. It should be understood that the term GUI 165 may be used in the singular or in the plural to describe one or more GUIs 165 and each of the displays of a particular GUI 165.

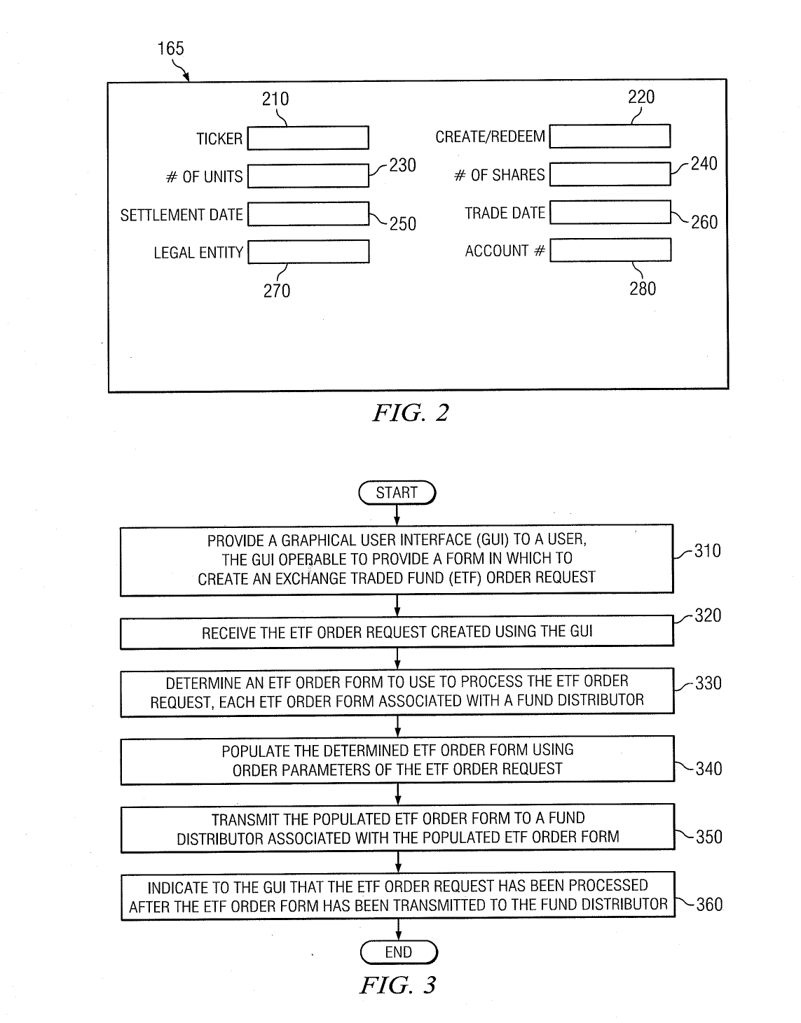

In some embodiments, GUI 165 may be a web-based application that is provided by computer system 140 over network 120 and displayed in any appropriate internet browser, including, but not limited to, Microsoft Internet Explorer, Mozilla Firefox, Google Chrome, Apple Safari, Opera, a browser of a smartphone, or any other appropriate browser. A particular embodiment of GUI 165 is illustrated in FIG. 2. In this embodiment, GUI 165 includes a ticker input box 210, a create/redeem input box 220, a number of units input box 230, a number of shares input box 240, a settlement date input box 250, a trade date box 260, a legal entity box 270, and an account number box 280. While FIG. 2 illustrates a particular embodiment of GUI 165, it should be understood that other embodiments of GUI 165 may include more or fewer input boxes and may be arranged in any appropriate configuration.

Ticker input box 210 of GUI 165 provides a location where user 135 may indicate a particular ETF symbol to create or redeem. For example, if user 135 wishes to place a create or redeem request for Standard & Poor's 500 Index Depository Receipts, the ticker for this ETF (“SPY”) could be entered into ticker input box 210. Create/redeem input box 220 provides a location where user 135 may indicate whether the particular ETF identified in ticker input box 210 is to be created or redeemed. In some embodiments, for example, create/redeem input box 220 may be a drop-down list that includes a create option and a redeem option. Number of units input box 230 and number of shares input box 240 provide a location where user 135 may indicate an amount of the particular ETF identified in ticker input box 210 that is to be created or redeemed. In one embodiment, for example, user 135 is required to enter an amount in only one of box 230 or box 240 and the other box will be automatically populated with the appropriate value. For example, user 135 may enter a value in number of units input box 230 and the number of shares may be automatically calculated and populated into number of shares input box 240. Finally, settlement date input box 250 provides user 135 a location to indicate a date when the particular ETF identified in ticker input box 210 is to be created or redeemed.

Trade date box 260 provides user 135 a location to indicate a trade date for the particular ETF identified in ticker input box 210. In certain embodiments, trade date box 260 may be automatically populated with an applicable trade date for the particular ETF identified in ticker input box 210, such as the current date. In other embodiments, trade date box 260 may be a drop-down list to provide two selectable trade dates such as the current date or the next possible trade date. Legal entity box 270 provides user 135 a location to indicate a name for the user's legal entity. In certain embodiments, legal entity box 270 may be automatically populated based on user 135 or previously set entitlements. Account number box 280 provides user 135 a location to indicate an appropriate account number associated with ETF request 117. For example, user 135 may enter an account number in account number box 280 in which to book the particular ETF identified in ticker input box 210.

Returning to FIG. 1, placement agents 130 may include any entity or organization, such as a bank, that accepts or rejects ETF creations and redemptions on behalf of a fund distributor that oversees and manages the ETF. Placement agents 130 may include one or more computer systems communicatively coupled to network 120 or PSTN 125 and capable of executing ETF requests from client 135. In some embodiments, placement agents 130 may include any computer system that accepts ETF requests for a particular ticker symbol. In some embodiments, placement agents 130 may refer to any suitable agent bank that acts as a custodian for the ETF, any fund distributor that oversees and manages ETFs, or any other entity that facilitates settlement of ETF creations and redemptions.

In certain embodiments, network 120 may refer to any interconnecting system capable of transmitting audio, video, signals, data, messages, or any combination of the preceding. Network 120 may include all or a portion of a public switched telephone network, such as PSTN 125, a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof. In some embodiments, network 120 and PSTN 125 may refer to the same network.

In some embodiments, enterprise 110 may refer to a financial institution such as a bank or a middle office of a bank and may include one or more computer systems 140. Computer systems 140 perform one or more steps of one or more methods described or illustrated herein. In particular embodiments, one or more computer systems 140 provide functionality described or illustrated herein. In particular embodiments, software running on one or more computer systems 140 performs one or more steps of one or more methods described or illustrated herein or provides functionality described or illustrated herein. Particular embodiments include one or more portions of one or more computer systems 140.

This disclosure contemplates any suitable number of computer systems 140. This disclosure contemplates computer system 140 taking any suitable physical form. As example and not by way of limitation, computer system 140 may be a virtual machine (VM), an embedded computer system, a system-on-chip (SOC), a single-board computer system (SBC) (e.g., a computer-on-module (COM) or system-on-module (SOM)), a desktop computer system, a laptop or notebook computer system, an interactive kiosk, a mainframe, a mesh of computer systems, a server, an application server, or a combination of two or more of these. Where appropriate, computer system 140 may include one or more computer systems 140; be unitary or distributed; span multiple locations; span multiple machines; or reside in a cloud, which may include one or more cloud components in one or more networks. Where appropriate, one or more computer systems 140 may perform without substantial spatial or temporal limitation one or more steps of one or more methods described or illustrated herein. As an example and not by way of limitation, one or more computer systems 140 may perform in real time or in batch mode one or more steps of one or more methods described or illustrated herein. One or more computer systems 140 may perform at different times or at different locations one or more steps of one or more methods described or illustrated herein, where appropriate.

In some embodiments, computer system 140 may execute any suitable operating system such as IBM's zSeries/Operating System (z/OS), MS-DOS, PC-DOS, MAC-OS, WINDOWS, UNIX, OpenVMS, an operating system based on LINUX, or any other appropriate operating system, including future operating systems. In some embodiments, computer system 140 may be a web server running web server applications such as Apache, Microsoft's Internet Information Server™, and the like.

In particular embodiments, computer system 140 includes a processor 142, memory 144, storage device 146, an input/output (I/O) interface 148, a communication interface 152, and a bus 154. Although this disclosure describes and illustrates a particular computer system having a particular number of particular components in a particular arrangement, this disclosure contemplates any suitable computer system having any suitable number of any suitable components in any suitable arrangement.

In particular embodiments, processor 142 includes hardware for executing instructions, such as those making up a computer program 150. As an example and not by way of limitation, to execute instructions, processor 142 may retrieve (or fetch) the instructions from an internal register, an internal cache, memory 144, or storage device 146; decode and execute the instructions; and then write one or more results to an internal register, an internal cache, memory 144, or storage device 146. In particular embodiments, processor 142 may include one or more internal caches for data, instructions, or addresses. This disclosure contemplates processor 142 including any suitable number of any suitable internal caches, where appropriate. As an example and not by way of limitation, processor 142 may include one or more instruction caches, one or more data caches, and one or more translation lookaside buffers (TLBs). Instructions in the instruction caches may be copies of instructions in memory 144 or storage device 146, and the instruction caches may speed up retrieval of those instructions by processor 142. Data in the data caches may be copies of data in memory 144 or storage device 146 for instructions executing at processor 142 to operate on; the results of previous instructions executed at processor 142 for access by subsequent instructions executing at processor 142 or for writing to memory 144 or storage device 146; or other suitable data. The data caches may speed up read or write operations by processor 142. The TLBs may speed up virtual-address translation for processor 142. In particular embodiments, processor 142 may include one or more internal registers for data, instructions, or addresses. This disclosure contemplates processor 142 including any suitable number of any suitable internal registers, where appropriate. Where appropriate, processor 142 may include one or more arithmetic logic units (ALUs); be a multi-core processor; or include one or more processors 142. Although this disclosure describes and illustrates a particular processor, this disclosure contemplates any suitable processor.

In particular embodiments, memory 144 includes main memory for storing instructions such as computer program(s) 150 for processor 142 to execute, or data for processor 142 to operate on. As an example and not by way of limitation, computer system 140 may load instructions from storage device 146 or another source (e.g., another computer system 140) to memory 144. Processor 142 may then load the instructions from memory 144 to an internal register or internal cache. To execute the instructions, processor 142 may retrieve the instructions from the internal register or internal cache and decode them. During or after execution of the instructions, processor 142 may write one or more results (which may be intermediate or final results) to the internal register or internal cache. Processor 142 may then write one or more of those results to memory 144. In particular embodiments, processor 142 executes only instructions in one or more internal registers or internal caches or in memory 144 (as opposed to storage device 146 or elsewhere) and operates only on data in one or more internal registers or internal caches or in memory 144 (as opposed to storage device 146 or elsewhere). One or more memory buses (which may each include an address bus and a data bus) may couple processor 142 to memory 144. Bus 154 may include one or more memory buses, as described below. In particular embodiments, one or more memory management units (MMUs) reside between processor 142 and memory 144 and facilitate accesses to memory 144 requested by processor 142.

In certain embodiments, instructions executed by processor 142 may reside in one or more computer programs 150. Computer program 150 generally refers to instructions, logic, rules, algorithms, code, tables, or other suitable instructions for performing the described functions and operations. In some embodiments, computer program 150 may be stored in memory 144, storage device 146, or any other location accessible to computer system 140. Where appropriate, computer program 150 may include one or more computer programs 150; be unitary or distributed; span multiple locations; span multiple machines; or reside in a cloud.

In particular embodiments, storage device 146 includes mass storage for data or instructions such as computer program 150. As an example and not by way of limitation, storage device 146 may include an HDD, a floppy disk drive, flash memory, an optical disc, a magneto-optical disc, magnetic tape, a Universal Serial Bus (USB) drive, a solid-state drive (SSD), or a combination of two or more of these. Storage device 146 may include removable or non-removable (or fixed) media, where appropriate. Storage device 146 may be internal or external to computer system 140, where appropriate. In particular embodiments, storage device 146 is non-volatile, solid-state memory. In particular embodiments, storage device 146 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates storage device 146 taking any suitable physical form. Storage device 146 may include one or more storage control units facilitating communication between processor 142 and storage device 146, where appropriate. Where appropriate, storage device 146 may include one or more storage devices 146. Although this disclosure describes and illustrates particular storage, this disclosure contemplates any suitable storage.

In particular embodiments, I/O interface 148 includes hardware, software, or both providing one or more interfaces for communication between computer system 140 and one or more I/O devices. System 100 may include one or more of these I/O devices, where appropriate. One or more of these I/O devices may enable communication between a person and computer system 140. As an example and not by way of limitation, an I/O device may include a keyboard, keypad, microphone, monitor, mouse, printer, scanner, speaker, still camera, stylus, tablet, touchscreen, trackball, video camera, another suitable I/O device or a combination of two or more of these. An I/O device may include one or more sensors. This disclosure contemplates any suitable I/O devices and any suitable I/O interfaces 148 for them. Where appropriate, I/O interface 148 may include one or more devices or software drivers enabling processor 142 to drive one or more of these I/O devices. I/O interface 148 may include one or more I/O interfaces 148, where appropriate. Although this disclosure describes and illustrates a particular I/O interface, this disclosure contemplates any suitable I/O interface.

In particular embodiments, communication interface 152 includes hardware, software, or both providing one or more interfaces for communication (e.g., packet-based communication and facsimile communication) between computer system 140 and one or more other computer systems 140, one or more networks such as network 120 and PSTN 125, and placement agents 130. As an example and not by way of limitation, communication interface 152 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 152 for it. As an example and not by way of limitation, computer system 140 may communicate with an ad hoc network, a personal area network (PAN), a local area network (LAN), a wide area network (WAN), a metropolitan area network (MAN), one or more portions of the Internet, a PSTN such as PSTN 125, or a combination of two or more of these. One or more portions of one or more of these networks may be wired or wireless. As an example, computer system 140 may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. Computer system 140 may include any suitable communication interface 152 for any of these networks, where appropriate. Communication interface 152 may include one or more communication interfaces 152, where appropriate. Although this disclosure describes and illustrates a particular communication interface, this disclosure contemplates any suitable communication interface.

In particular embodiments, bus 154 includes hardware, software, or both coupling components of computer system 140 to each other. As an example and not by way of limitation, bus 154 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 154 may include one or more buses 154, where appropriate. Although this disclosure describes and illustrates a particular bus, this disclosure contemplates any suitable bus or interconnect.

In operation, one or more computer systems 140 of enterprise 110 may offer ETF request processing services to users 135 via clients 115. In some embodiments, for example, computer systems 140 may be controlled or operated by a middle office of enterprise 110 that is communicatively coupled to both clients 115 and placement agents 130. First, a user 135 may utilize GUI 165 on client 115 to provide an ETF request 117 to computer system 140. In some embodiments, user 135 may utilize a web application on client 115 to create ETF request 117. In these embodiments, computer systems 140 include web servers that generate content for GUI 165 over network 120.

After GUI 165 is utilized to generate ETF request 117, it may then be transmitted to computer system 140 over network 120 via email or any other suitable method. In certain embodiments, ETF request 117 includes, among other things, a ticker symbol for a particular ETF that was entered into ticker input box 210, an indication from create/redeem input box 220 of whether user 135 wishes to create or redeem the particular ETF, an amount of the particular ETF to create or redeem from either number of units input box 230 or number of shares input box 240, and a settlement date from settlement date input box 250.

In certain embodiments, an ETF request 117 may be directly input into computer system 140 on behalf of a user 135 by someone within enterprise 110. For example, an administrator or employee of enterprise 110 may communicate with user 135 and as a result may create ETF request 117 on behalf of user 135. In these embodiments, the administrator or employee of enterprise 110 may utilize a client 115 of enterprise 110 to create ETF request 117 for user 135.

After receiving ETF request 117, computer system 140 may transmit acknowledgement 119 to user 135 via client 115 to indicate that ETF request 117 has been received or has been rejected. Before transmitting acknowledgment 119, some embodiments of computer system 140 may first analyze received ETF request 117 in order to determine a criteria 158 associated with the ticker symbol of the ETF request 117. For example, computer system 140 may determine the ticker symbol that was entered into ticker input box 210 and included in the ETF request 117. Based on the determined ticker symbol, computer system 140 may then determine a criteria 158 associated with the determined ticker symbol of ETF request 117. In some embodiments, the determined criteria is chosen from a plurality of criteria 158 stored in memory 144, computer program 150, storage 146, or any other memory accessible to computer system 140. In certain embodiments, the determined criteria 158 is chosen by matching the ticker symbol of ETF request 117 with a ticker symbol of criteria 158.

After determining a criteria 158 to use for received ETF request 117, computer system 140 may compare the received ETF request 117 with the determined criteria 158 in order to determine whether to reject or accept ETF request 117. For example, the determined criteria 158 may include instructions to reject any ETF request for a particular ETF if it is not received during a specific time period. For illustrative purposes only, a criteria 158 for a particular ETF may indicate to reject any ETF request 117 for the particular ETF if the request is received after 4 PM.

In some embodiments, user 135 or an administrator or employee of enterprise 110 may cancel or modify ETF request 117 after it has been transmitted to computer system 140. For example, user 135 may utilize GUI 165 of client 115 in order to view ETF request 117 and subsequently modify or cancel ETF request 117. As another example, an administrator or employee of enterprise 110 may utilize a GUI 165 of a client 115 of enterprise 110 in order to view ETF request 117 received from user 135 and subsequently modify or cancel ETF request 117.

After receiving ETF request 117, computer system 140 determines, based on the ticker symbol of ETF request 117, an appropriate ETF request form 156 to use to process received ETF request 117. ETF request forms 156 may be electronic files that are based on forms required by placement agents 130 for ETF transactions. In some embodiments, each placement agent 130 may require a unique ETF request form 156 to process ETF transactions. ETF request forms 156 may be stored in any memory accessible to computer system 140 including, but not limited to, memory 144, computer program 150, or storage 146.

To determine an appropriate ETF request form 156 to use to process received ETF request 117, computer system 140 may first determine the ticker symbol that was entered into ticker input box 210 and included in ETF request 117. Based on the determined ticker symbol, computer system 140 may then determine from ETF request forms 156 an ETF request form associated with the determined ticker symbol of ETF request 117. In certain embodiments, the determined ETF request form 156 is chosen by matching the ticker symbol of ETF request 117 with a ticker symbol of ETF request form 156.

After determining an appropriate ETF request form 156 to use to process received ETF request 117, computer system 140 may then populate the determined ETF request form 156 using parameters of ETF request 117. In some embodiments, parameters of ETF request 117 may include a ticker symbol for a particular ETF that was entered into ticker input box 210, a create/redeem indicator from create/redeem input box 220, and an amount of ETFs from number of units input box 230 or number of shares input box 240.

After ETF request form 156 has been populated, it is transmitted to a placement agent 130 associated with the populated ETF request form 156. In certain embodiments, placement agent 130 associated with the populated ETF request form 156 is the placement agent 130 that issued the ETF of ETF request 117. In some embodiments, ETF request form 156 may be transmitted as a facsimile over PSTN 125 or network 120. In other embodiments, computer system 140 may directly interface with a computer system of placement agents 130 and may electronically transmit parameters of ETF request 117 directly to a placement agent 130 associated with the populated ETF request form 156.

After transmitting ETF request form 156 to placement agent 130, computer system 140 may receive a receipt 123 from placement agent 130 to confirm that ETF request form 156 has been received. In some embodiments, receipt 123 may be transmitted as a facsimile or an email over PSTN 125 or network 120. In other embodiments, computer system 140 may directly interface with a computer system of placement agents 130 and receipt 123 may be a direct electronic communication to computer system 140.

Finally, computer system 140 may transmit a confirmation 121 to client 115 to indicate to user 135 that ETF request 117 has been processed. In some embodiments, confirmation 121 may be transmitted to client 115 after ETF request form 156 has been transmitted to placement agent 130. In other embodiments, confirmation 121 may be transmitted to client 115 after an receipt 123 is received at computer system 140 from placement agent 130. As a result, user 135 is provided ETF request processing services in a timely, efficient, and accurate manner.

FIG. 3 illustrates one embodiment of a method 300 for providing ETF request processing services to users 135. Method 300 may be implemented, for example, by one or more computer programs 150 in computer systems 140. Method 300 begins in step 310 where a GUI is provided to a user. In some embodiments, the provided GUI includes a form in which to create an ETF request. In some embodiments, the ETF request created in step 310 may refer to ETF request 117 described above. In certain embodiments, the GUI provided to a user may refer to GUI 165 described above.

In step 320, the ETF request created using the GUI in step 310 is received at a computer system such as computer system 140 described above. In certain embodiments, the received ETF request includes parameters such as a ticker symbol, a create/redeem indicator, and an amount of ETFs. In some embodiments, the ETF request received in step 320 may refer to ETF request 117 described above.

In step 330, the computer system determines, based on a ticker symbol of the ETF request, an ETF request form to use to process the received ETF request. In some embodiments, the ETF request form is chosen from a plurality of ETF request forms that are stored in memory accessible to the computer system. In some embodiments, each ETF request form is associated with a placement agent. In certain embodiments, the ETF request form of step 330 may refer to ETF request form 156 described above.

In step 340, the computer system populates the determined ETF request form of step 330 using the parameters of the ETF request received in step 320. In step 350, the populated ETF request form is transmitted to a placement agent associated with the ETF request form populated in step 340. In some embodiments, the ETF request form of step 350 is transmitted by facsimile to the placement agent.

In step 360, the computer system may optionally indicate in the GUI of step 310 that the ETF request transmitted in step 350 has been processed. In some embodiments, the indication is displayed in the GUI after the ETF request form has been transmitted to the placement agent in step 350. After step 360, method 300 ends.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Herein, “ETF” is inclusive of any type of exchange traded fund. For example, “ETF” as used herein includes, but is not limited to, index ETFs, commodity ETFs, bond ETFs, currency ETFs, actively managed ETFs, exchange-traded grantor trusts, Holding Company Depositary Receipts (HOLDRs), and leveraged ETFs. In addition, while this disclosure describes a system and method for ETF request management, this disclosure encompasses any type of traded investment including, but not limited to, stocks, mutual funds, commodities, bonds, and the like.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, capable, configured, enabled, operable, or operative.

What is claimed is:

1. A server, comprising:
a memory operable to store a plurality of Exchange Traded Fund (ETF) request forms, each ETF request form associated with a placement agent; and
a processor communicatively coupled to the memory and operable to:
provide a graphical user interface (GUI) to a user, the GUI operable to provide a form in which to create an ETF request;
receive the ETF request created using the GUI, the ETF request comprising parameters, the parameters comprising a ticker symbol, a create/redeem indicator, and an amount of ETFs;
determine, based on the ticker symbol of the ETF request, an ETF request form to use to process the ETF request, the ETF request form selected from the plurality of ETF request forms stored in the memory;
populate the determined ETF request form using the parameters of the ETF request;
transmit the populated ETF request form to a placement agent associated with the populated ETF request form; and
indicate, using the GUI, that the ETF request has been processed after the ETF request form has been transmitted to the placement agent.

2. The server of claim 1, the processor further operable to:
determine a criteria associated with the ticker symbol of the ETF request, the criteria chosen from a plurality of criteria stored in the memory;
reject the received ETF request if the ETF request does not meet the determined criteria; and
accept the received ETF request if the ETF request meets the determined criteria.

3. The server of claim 1, wherein transmitting the populated ETF request form to a placement agent associated with the populated ETF request form comprises transmitting the populated ETF request form to the placement agent via facsimile.

4. The server of claim 1, wherein transmitting the populated ETF request form to a placement agent associated with the populated ETF request form comprises transmitting the populated ETF request form to the placement agent via email.

5. The server of claim 1, the processor further operable to receive from the placement agent a confirmation after the populated ETF request form has been transmitted to the placement agent.

6. A method comprising:
providing, by a computer system, a graphical user interface (GUI) to a user, the GUI operable to provide a form in which to create an Exchange Traded Fund (ETF) request;
receiving, at the computer system, the ETF request created using the GUI, the ETF request comprising parameters, the parameters comprising a ticker symbol, a create/redeem indicator, and an amount of ETFs;
determining, by the computer system based on the ticker symbol of the ETF request, an ETF request form to use to process the ETF request, the ETF request form selected from a plurality of ETF request forms stored in memory accessible to the computer system, each ETF request form associated with a placement agent;
populating, by the computer system, the determined ETF request form using the parameters of the ETF request;
transmitting, by the computer system, the populated ETF request form to a placement agent associated with the populated ETF request form; and
indicating, by the computer system using the GUI, that the ETF request has been processed after the ETF request form has been transmitted to the placement agent.

7. The method of claim 6, further comprising:
determining, by the computer system, a criteria associated with the ticker symbol of the ETF request, the criteria chosen from a plurality of criteria stored in memory accessible to the computer system;
rejecting, by the computer system, the received ETF request if the ETF request does not meet the determined criteria; and
accepting, by the computer system, the received ETF request if the ETF request meets the determined criteria.

8. The method of claim 6, wherein transmitting the populated ETF request form to a placement agent associated with the populated ETF request form comprises transmitting the populated ETF request form to the placement agent via facsimile.

9. The method of claim 6, wherein transmitting the populated ETF request form to a placement agent associated with the populated ETF request form comprises transmitting the populated ETF request form to the placement agent via email.

10. The method of claim 6, further comprising receiving, at the computer system from the placement agent, a confirmation after the populated ETF request form has been transmitted to the placement agent.

11. A system, comprising:
a storage device operable to store a plurality of Exchange Traded Fund (ETF) request forms, each ETF request form associated with a placement agent; and
a server communicatively coupled to the storage device, the server comprising a processor;
wherein the server is operable to:
provide a graphical user interface (GUI) to a user, the GUI operable to provide a form in which to create an ETF request;
receive the ETF request created using the GUI, the ETF request comprising parameters, the parameters comprising a ticker symbol, a create/redeem indicator, and an amount of ETFs;
determine, based on the ticker symbol of the ETF request, an ETF request form to use to process the ETF request, the ETF request form selected from the plurality of ETF request forms stored in the memory;
populate the determined ETF request form using the parameters of the ETF request;
transmit the populated ETF request form to a placement agent associated with the populated ETF request form; and
indicate, using the GUI, that the ETF request has been processed after the ETF request form has been transmitted to the placement agent.

12. The system of claim 11, the server further operable to:
determine a criteria associated with the ticker symbol of the ETF request, the criteria chosen from a plurality of criteria stored in the storage device;
reject the received ETF request if the ETF request does not meet the determined criteria; and
accept the received ETF request if the ETF request meets the determined criteria.

13. The system of claim 11, wherein transmitting the populated ETF request form to a placement agent associated with the populated ETF request form comprises transmitting the populated ETF request form to the placement agent via facsimile.

14. The system of claim 11, wherein transmitting the populated ETF request form to a placement agent associated with the populated ETF request form comprises transmitting the populated ETF request form to the placement agent via email.

15. The system of claim 11, the server further operable to receive from the placement agent a confirmation after the populated ETF request form has been transmitted to the placement agent.

16. One or more computer-readable non-transitory storage media embodying software this is operable when executed by one or more computer systems to:
provide a graphical user interface (GUI) to a user, the GUI operable to provide a form in which to create an Exchange Traded Fund (ETF) request;
receive the ETF request created using the GUI, the ETF request comprising parameters, the parameters comprising a ticker symbol, a create/redeem indicator, and an amount of ETFs;
determine, based on the ticker symbol of the ETF request, an ETF request form to use to process the ETF request, the ETF request form selected from a plurality of ETF request forms stored in the media, each ETF request form associated with a placement agent;
populate the determined ETF request form using the parameters of the ETF request;
transmit the populated ETF request form to a placement agent associated with the populated ETF request form; and
indicate, using the GUI, that the ETF request has been processed after the ETF request form has been transmitted to the placement agent.

17. The media of claim 16, the software further operable to:
determine a criteria associated with the ticker symbol of the ETF request, the criteria chosen from a plurality of criteria stored in the media;
reject the received ETF request if the ETF request does not meet the determined criteria; and
accept the received ETF request if the ETF request meets the determined criteria.

18. The media of claim 16, wherein transmitting the populated ETF request form to a placement agent associated with the populated ETF request form comprises transmitting the populated ETF request form to the placement agent via facsimile.

19. The media of claim 16, wherein transmitting the populated ETF request form to a placement agent associated with the populated ETF request form comprises transmitting the populated ETF request form to the placement agent via email.

20. The media of claim 16, the software further operable to receive from the placement agent a confirmation after the populated ETF request form has been transmitted to the placement agent.
